(19) United States
(12) Patent Application Publication
(10) Pub. No.: US 2025/0314418 A1
(43) Pub. Date: Oct. 9, 2025

(54) REFRIGERATOR DOOR WITH REVERSIBLE HINGE LOCATION AND METHOD OF FIXING HINGE LOCATION

(71) Applicant: Airxcel, Inc., Wichita, KS (US)

(72) Inventors: Christopher S. GREER, Syracuse, IN (US); Ryan D. STREETER, Mishawaka, IN (US)

(73) Assignee: Airxcel, Inc., Wichita, KS (US)

(21) Appl. No.: 19/173,520

(22) Filed: Apr. 8, 2025

Related U.S. Application Data
(60) Provisional application No. 63/631,598, filed on Apr. 9, 2024.

(51) Int. Cl. F25D 23/02; E05D 7/02

(52) U.S. Cl. CPC F25D 23/028; E05D 7/02; E05Y 2900/31; F25D 2323/024

(57) ABSTRACT

A refrigerator door mountable for swinging movement between opened and closed positions at the front opening of a refrigerator cabinet by a left-side hinge and a right-side hinge. A left-side handle is associated with the left-side hinge and may be manipulated to release a hinge catch to free a hinge pin of the left-side hinge from a captured condition to allow a left-hand swing opening and closing of the refrigerator door about a hinge pin of the right-side hinge while in a captured condition. A right-side handle is associated with the right-side hinge and is manipulable to release a hinge catch to free the hinge pin of the right-side hinge from a captured condition to allow a right-hand swing opening and closing of the refrigerator door about the hinge pin of the left-side hinge while in a captured condition. A removable hinge block may be positioned to place the hinge pin of the right-side hinge in the captured condition to allow the left-hand swing opening and closing of the refrigerator door or may alternatively be positioned to place the hinge pin of the left-side hinge in the captured condition to allow the right-hand swing opening and closing of the refrigerator door.

### BACKGROUND

The present disclosure relates generally to a refrigerator and, more particularly, to a refrigerator door and fixing a location of the hinges about which the refrigerator door swings between opened and closed positions.

Refrigerator doors are typically mounted by upper and lower hinge brackets to a cabinet of the refrigerator. During manufacture of the refrigerator, the hinges are typically placed at the right side of the cabinet and a handle for opening the refrigerator door is placed at the left side of the refrigerator door. A refrigerator configured in this manner is referred to as having a right-hand swing of the refrigerator door. The manufactured refrigerator will normally include threaded mounting holes for repositioning of the hinges on the left side of the cabinet and the handle on the rights side of the refrigerator door so that the refrigerator can be converted to a left-hand refrigerator door swing, such as when the refrigerator is to be installed next to a wall or a countertop that makes the left-hand refrigerator door swing more practical. While removing and repositioning the hinges and handle is normally a straight-forward process, it can be time-consuming and may require the assistance of a second individual.

Another type of refrigerator door, referred to as a dual-swing refrigerator door, has hinges and handles mounted at both the left and right sides of the refrigerator door so that the refrigerator door may be opened with either a left-hand or right-hand swing. When the user manipulates the handle on one side of the refrigerator door, an internal slide mechanism is moved by the handle manipulation to release a captured hinge pin on that side of the refrigerator door to allow swinging about the hinge pin on the opposite side of the refrigerator door. In order to prevent inadvertent removal of the refrigerator door by the user manipulating both handles at the same time, the internal slide mechanism is shifted by the manipulation of either handle to prevent release of the captured hinge pin at the opposite side of the refrigerator door. Upon release of the handle, the internal slide mechanism returns to a home position that again allows either handle to be manipulated to control the swing direction of the refrigerator door.

While dual-swing refrigerator doors allow the user to select between left-hand and right-hand swing of the refrigerator door based on which handle is manipulated, their design is more complicated and may be unnecessary in situations where only one swing direction is practical because of the presence of a wall or other impeding structure. A need has thus arisen for a refrigerator that allows the conversion between right-hand and left-hand swing of the refrigerator door to be accomplished without changing the hinge and handle location and without using the internal slide mechanism required for a dual-swing refrigeration door.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, the disclosure is directed to refrigerator comprising a cabinet defining a refrigeration compartment with a front opening; a refrigerator door mountable for swinging movement between opened and closed positions at the front opening of the cabinet by a left-side hinge comprising a mounting bracket and a hinge pin and a right-side hinge comprising a mounting bracket and a hinge pin; a left-side handle associated with the left-side hinge and manipulable to release a left hinge catch to free the hinge pin of the left-side hinge from a captured condition to allow a left-hand swing opening and closing of the refrigerator door about the hinge pin of the right-side hinge while in a captured condition; a right-side handle associated with the right-side hinge and manipulable to release a right hinge catch to free the hinge pin of the right-side hinge from a captured condition to allow a right-hand swing opening and closing of the refrigerator door about the hinge pin of the left-side hinge while in a captured condition; and a removable hinge block either positioned to place the hinge pin of the right-side hinge in the captured condition to allow the left-hand swing opening and closing of the refrigerator door or positioned to place the hinge pin of the left-side hinge in the captured condition to allow the right-hand swing opening and closing of the refrigerator door.

In another aspect, the disclosure is directed to a refrigerator comprising a cabinet defining refrigerator compartment with a front opening; a refrigerator door mountable for swinging movement between opened and closed positions at the front opening of the cabinet by upper and lower left-side hinges each comprising a mounting bracket and a hinge pin and upper and lower right-side hinges each comprising a mounting bracket and a hinge pin; a left-side handle associated with both the upper and lower left-side hinges and manipulable to release a left hinge catch to free the hinge pins of the upper and lower left-side hinges from a captured condition to allow a left-hand swing opening and closing of the refrigerator door about the hinge pins of the upper and lower right-side hinges while in a captured condition; a right-side handle associated with the both the upper and lower right-side hinges and manipulable to release a right hinge catch to free the hinge pins of the upper and lower right-side hinges from a captured condition to allow a right-hand swing opening and closing of the refrigerator door about the hinge pins of the upper and lower left-side hinge while in a captured condition; and removable hinge blocks either positioned to place the hinge pins of the upper and lower right-side hinges in the captured condition to allow the left-hand swing opening and closing of the refrigerator door or positioned to place the hinge pins of the upper and lower left-side hinges in the captured condition to allow the right-hand swing opening and closing of the refrigerator door.

In a further aspect, the disclosure is directed to a refrigerator comprising a cabinet defining refrigerator compartment with a front opening; a refrigerator door mountable for swinging movement between opened and closed positions at the front opening of the cabinet by upper and lower left-side hinges each comprising a mounting bracket and a hinge pin and upper and lower right-side hinges each comprising a mounting bracket and a hinge pin; a left-side handle associated with both the upper and lower left-side hinges and manipulable to release left hinge catches to free the hinge pins of the upper and lower left-side hinges from a captured condition to allow a left-hand swing opening and closing of the refrigerator door about the hinge pins of the upper and lower right-side hinges while in a captured condition; a right-side handle associated with the both the upper and lower right-side hinges and manipulable to release right hinge catches to free the hinge pins of the upper and lower right-side hinges from a captured condition to allow a right-hand swing opening and closing of the refrigerator door about the hinge pins of the upper and lower left-side hinge while in a captured condition; left guide channels positioned in the refrigerator door and receiving the hinge pins of the upper and lower left-side hinges; right guide channels positioned in the refrigerator door and receiving the hinge pins of the upper and lower right-side hinges; removable hinge blocks either positioned to place the hinge pins of the upper and lower right-side hinges in the captured condition to allow the left-hand swing opening and closing of the refrigerator door or positioned to place the hinge pins of the upper and lower left-side hinges in the captured condition to allow the right-hand swing opening and closing of the refrigerator door; and a handle block either positioned to prevent manipulation of the right-side handle when the hinge blocks are positioned to place the hinge pins of the upper and lower right-side hinges in the captured condition to allow the left-hand swing opening and closing of the refrigerator door or positioned to prevent manipulation of the left-side handle when the hinge blocks are positioned to place the hinge pins of the upper and lower left-side hinges in the captured condition to allow the right-hand swing opening and closing of the refrigerator door, wherein the hinge blocks are inserted into the right guide channels abutting the hinge pins of the upper and lower right-side hinges when the hinge blocks are positioned to place the hinge pins of the upper and lower right-side hinges in the captured condition to allow the left-hand swing opening and closing of the refrigerator door or the hinge blocks are inserted into the left guide channels abutting the hinge pins of the upper and lower left-side hinge when the hinge blocks are positioned to place the hinge pins of the upper and lower left-side hinges in the captured condition to allow the right-hand swing opening and closing of the refrigerator door, wherein the hinge blocks each have one end that abuts one of the hinge pins in the left guide channels when the hinge blocks are inserted into the left guide channels and abuts the hinge pins the right guide channels when the hinge blocks are inserted into the right guide channels.

### BRIEF DESCRIPTION OF THE DRAWINGS

The present technology is described in detail below with reference to the attached drawing figures, in which like numerals represent the same components, and wherein:

FIG. 1 is a perspective view of an embodiment of a refrigerator having a door constructed with a reversible hinge location;

FIG. 2 is a fragmentary perspective view of the refrigerator;

FIG. 3 is a fragmentary perspective view of the refrigerator, with the refrigerator door shown in a partially opened position using a right-hand swing;

FIG. 4 is a fragmentary perspective view of the refrigerator, with portions broken away to show details of a right-side hinge of the refrigerator door in a non-hinge configuration that allows the refrigerator door to be opened by manipulation of a right-side handle shown in the drawing;

FIG. 5 is a fragmentary perspective view of the refrigerator, with portions broken away to show further details of the right-side hinge of the refrigerator door;

FIG. 6 is a fragmentary perspective view of the refrigerator and similar to the view shown in FIG. 5 but taken from a different perspective;

FIG. 7 is a fragmentary perspective of the refrigerator with portions broken away to show the release of a hinge pin from the right-side hinge and the refrigerator door moved to a partially opened position using a right-hand swing;

FIG. 8 is an exploded top perspective view of the refrigerator door showing components of the right-side hinge and handle;

FIG. 9 is an exploded bottom perspective view of the refrigerator door showing components of the right-side hinge and handle;

FIG. 10 is a fragmentary perspective view of the refrigerator, showing an opposite side from that shown in FIGS. 4-9, with portions broken away to show details of a left-side hinge of the refrigerator door when in a closed position and having a hinge configuration with a hinge pin block installed to place the hinge pin in a captured condition and a handle block installed to prevent manipulation of the left-side handle;

FIG. 11 is a fragmentary perspective view of the refrigerator, with portions broken away to show further details of the left-side hinge of the refrigerator door in the hinge configuration shown in FIG. 10;

FIG. 12 is a fragmentary perspective view of the refrigerator with portions broken away to show the capture of a hinge pin in the left-side hinge when the refrigerator door in the hinge configuration shown in FIGS. 10 and 11; and

FIG. 13 is a fragmentary perspective view of the refrigerator with portions broken away to show the capture of a hinge pin in the left-side hinge when the refrigerator door is in an opened position using a right-hand swing.

### DETAILED DESCRIPTION

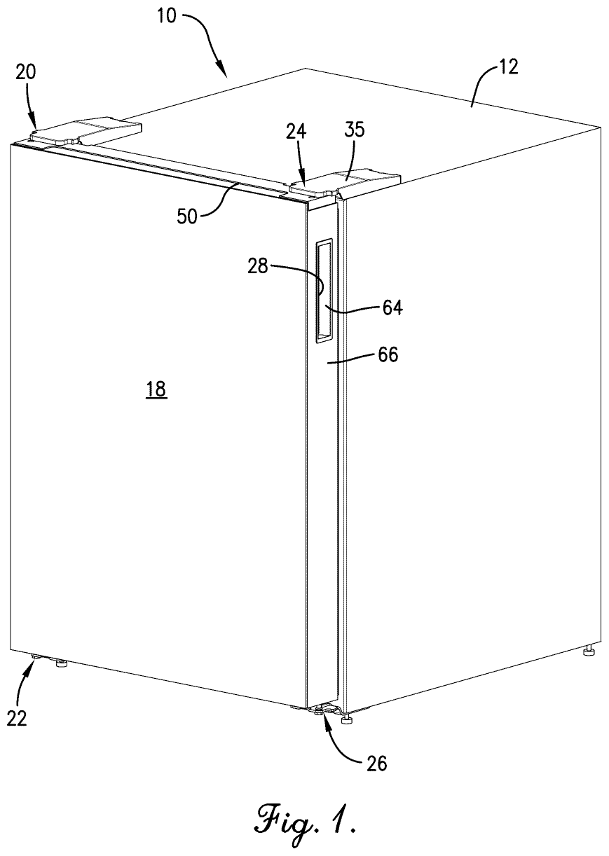

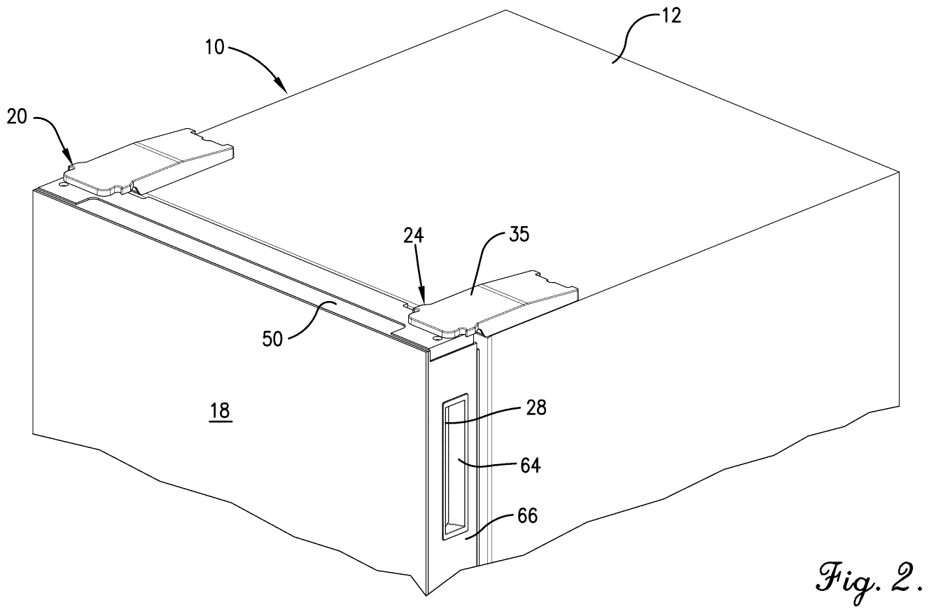

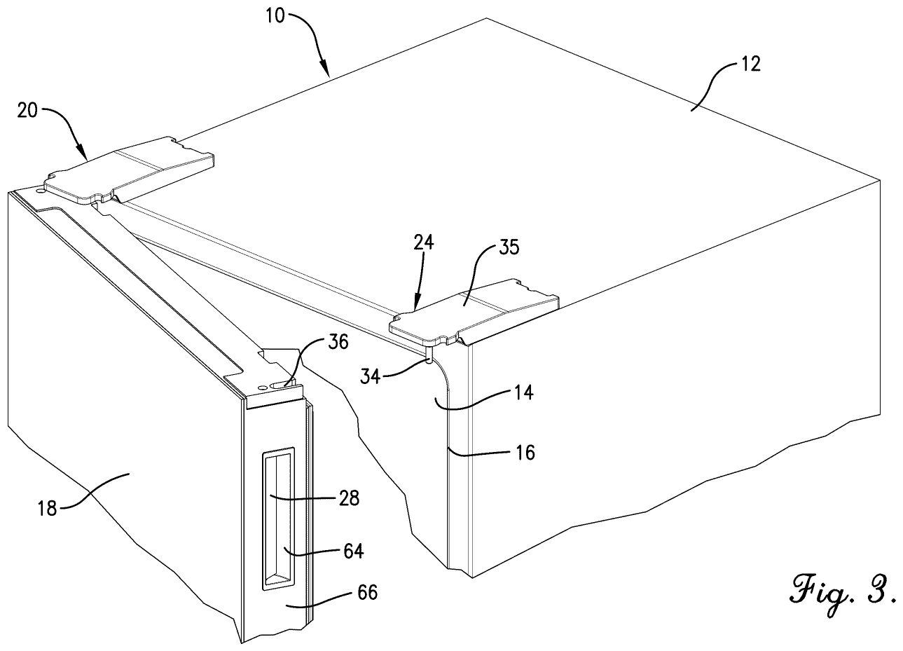

Turning now to the drawings in greater detail and initially to FIGS. 1-3, a refrigerator according to an embodiment of the present disclosure is represented generally by the numeral 10 and includes a cabinet 12 defining an internal refrigeration compartment 14 (FIG. 3) with a front opening 16 (FIG. 3). The internal refrigeration compartment 14 may be a freezer compartment in which foods are able to be maintained at preselected temperatures, such as at or below 0° F., or a refrigerator compartment in which foods are able to be maintained at temperatures above freezing, such as at or below 40° F. In various embodiments, the refrigerator 10 may have only a freezer compartment, only a refrigerator compartment, a freezer compartment positioned below a refrigerator compartment, or a freezer compartment positioned above a refrigerator compartment. As used herein, the term refrigerator 10 is intended to encompass each of these embodiments.

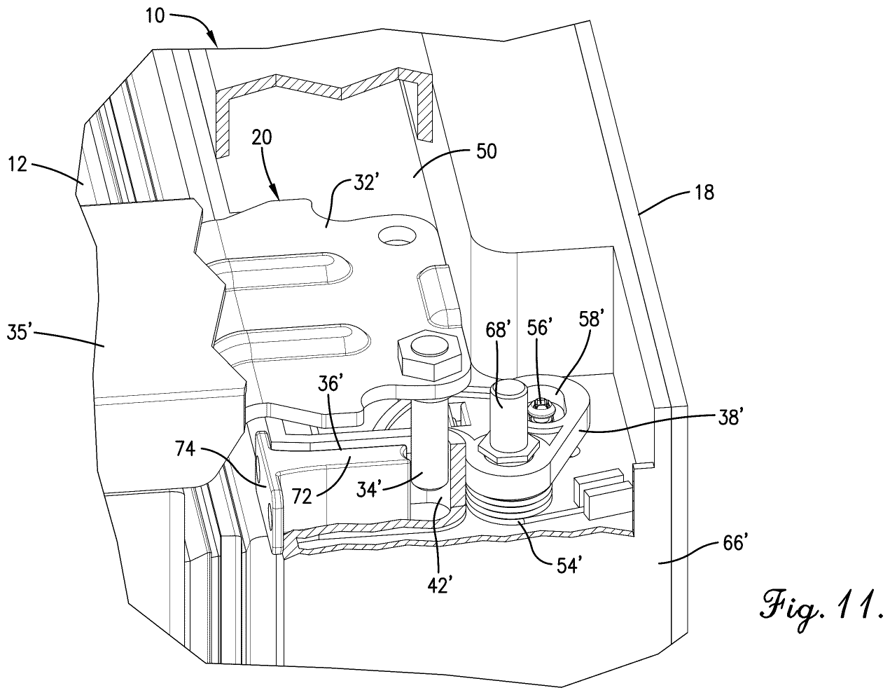

A refrigerator door 18 is mounted for swinging movement between opened and closed positions at the front opening 16 of the cabinet 12 by paired upper and lower left-side hinges 20 and 22 and paired upper and lower right-side hinges 24 and 26. As used herein, the term refrigerator door 18 is intended to encompass both a door used with a freezer compartment and a door used with a refrigerator compartment. As can be seen in FIG. 3, the paired upper and lower left-side hinges 20 and 22 allow a right-hand swing opening and closing of the refrigerator door 18. An opposite, left-hand swing opening and closing of the refrigerator door 18 using the paired upper and lower right-side hinges 24 and 26 is illustrated in FIG. 11.

A right-side handle 28 in the refrigerator door 18 is associated with one or both of the upper and lower right-side hinges 24 and 26 and may be manipulated by a user to allow the right-hand swing opening and closing of the refrigerator door 18. Similarly, a left-side handle 30 is associated with one or both of the upper and lower left-side handles 20 and 22 and may be manipulated by a user to allow the left-hand swing opening and closing of the refrigerator door 18.

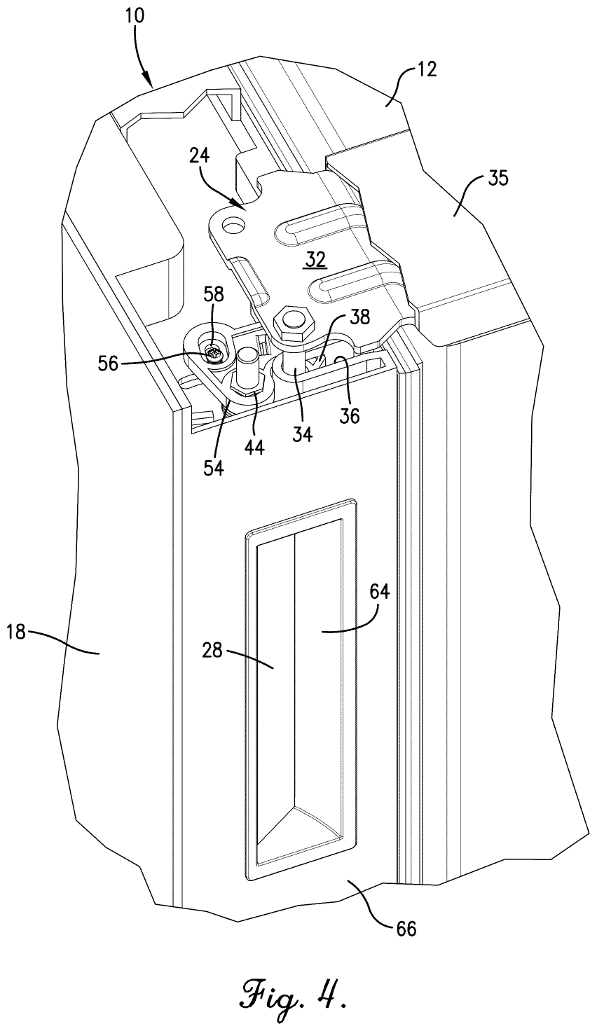

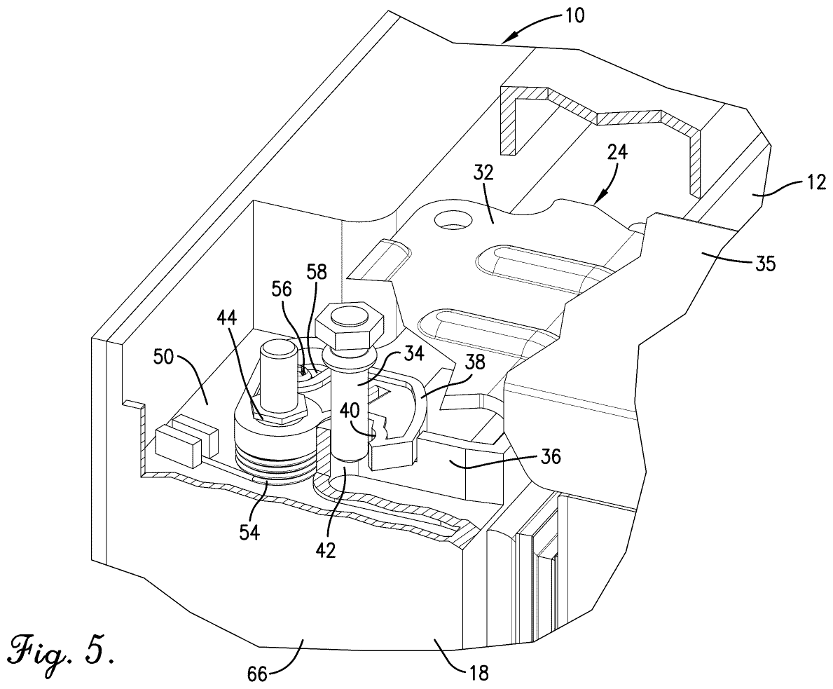

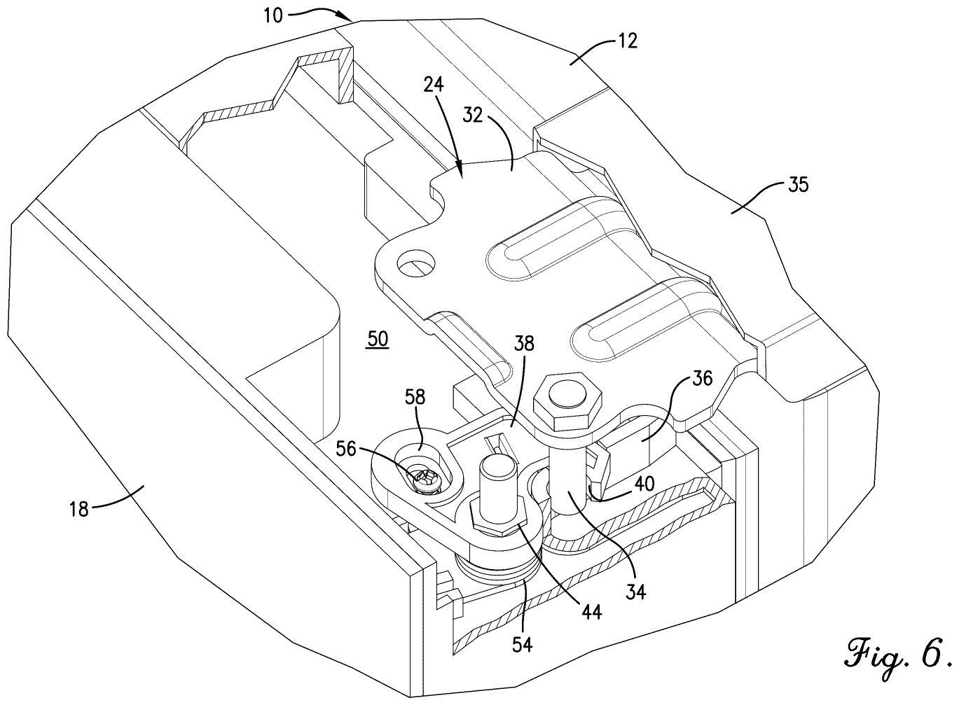

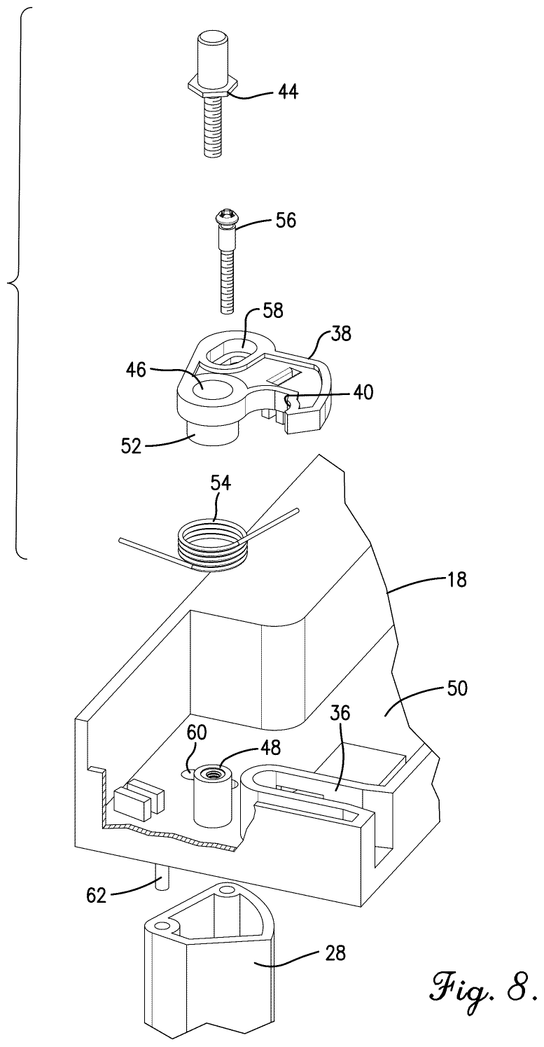

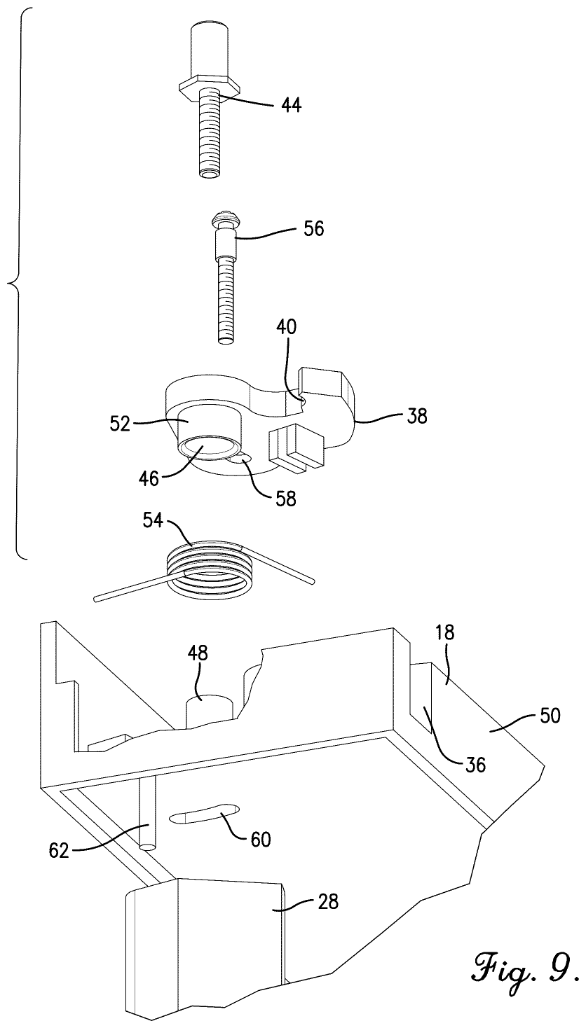

In one embodiment, the upper and lower left-side hinges 20 and 22 may be of a similar or mirror image construction and the upper and lower right-side hinges 24 and 26 may likewise be of a similar construction or mirror image construction. In a representative example, as shown in FIGS. 4-9, the upper right-side hinge 24 may comprise a mounting bracket 32 that is secured to the cabinet 12 and extends over the refrigerator door 18 and a hinge pin 34 that is secured to the mounting bracket 32 and extends vertically downward a sufficient distance to be received within the refrigerator door 18. The upper right-side hinge 24 may include a decorative cover 35 that snaps onto the mounting bracket 32. In one embodiment, the hinge pin 34 is received within a right guide channel 36 that is located below a top surface of the refrigerator door 18. The right guide channel 36 is open at its end that is closest to the cabinet 12 and is closed at its opposite end that is further away from the cabinet 12.

A right hinge catch 38 is moveable between deployed and released positions by manipulation of the right-side handle 28, as described below. In the deployed position, the hinge catch 38 extends into the right guide channel 36 and abuts the hinge pin 34 to form to place the hinge pin 34 in a captured condition that prevents movement of the hinge pin along the right guide channel 36 until the hinge catch is moved to the released position. In one embodiment, the hinge catch 38 includes a semi-circular surface 40 that abuts against the hinge pin 34 and in combination with the closed end of the right guide channel 36 forms a cylindrical barrel 42 that releasably captures the hinge pin 34.

The hinge catch 38 may rotate between the deployed and released positions about a vertical pivot axis formed by a threaded bolt 44 that extends through a hole 46 formed in the hinge catch 38 and is turned into an upstanding threaded boss 48 mounted on an upper frame 50 of the refrigerator door 18. The hinge catch 38 may include a hub 52 that projects downwardly to surround the boss 48 and receive a torsion or other type of spring 54 that urges rotation of the hinge catch 38 toward the deployed position.

The hinge catch 38 may be operably coupled with the right-side handle 28 in one embodiment by various types of linkages. In one embodiment, a post 56 extends vertically downward through a closed-ended slot 58 in the hinge catch 38 and an aligned closed-ended slot 60 in the upper frame 50 of the refrigerator door 18. A lower end of the post 56 is secured to the right-side handle 28 at a positioned spaced from a vertical pivot axis of the right-side handle 28 formed by a pivot pin 62.

The rotation force of the torsion spring 54 acting on the hinge catch 38 is transmitted to the right-side handle 28 to urge it toward a released position by an end of the slot 58 in the hinge catch 38 engaging the post 56, which in turn urges the right-side handle 28 to rotate about pivot pin 62 in the direction toward the released position. When a user manipulates the right-side handle 28 by reaching through a handle opening 64 (FIG. 4) formed in a side frame 66 of the refrigerator door 18 and exerts a squeezing force against the right-side handle 28 sufficient to overcome the opposite rotation force of the torsion spring 54, the right-side handle 28 is rotated toward its engaged position. As the right-side handle 28 is rotated in this fashion, the post 56 engages against the opposed end of the slot 58, which causes the hinge catch 38 to rotate toward its released position. This movement of the hinge catch 38 removes the semi-circular surface 40 away from abutting against the hinge pin 34 in the right guide channel 36 and thereby frees the hinge pin 34 from its captured condition to allow the right-hand swing opening and closing of the refrigerator door 18. The right-side handle 28 may extend vertically between the upper and lower right-side hinges 24 and 26 so that it is operable to simultaneously move the hinge catches 38 associated with both the upper and lower right-side hinges 24 and 26.

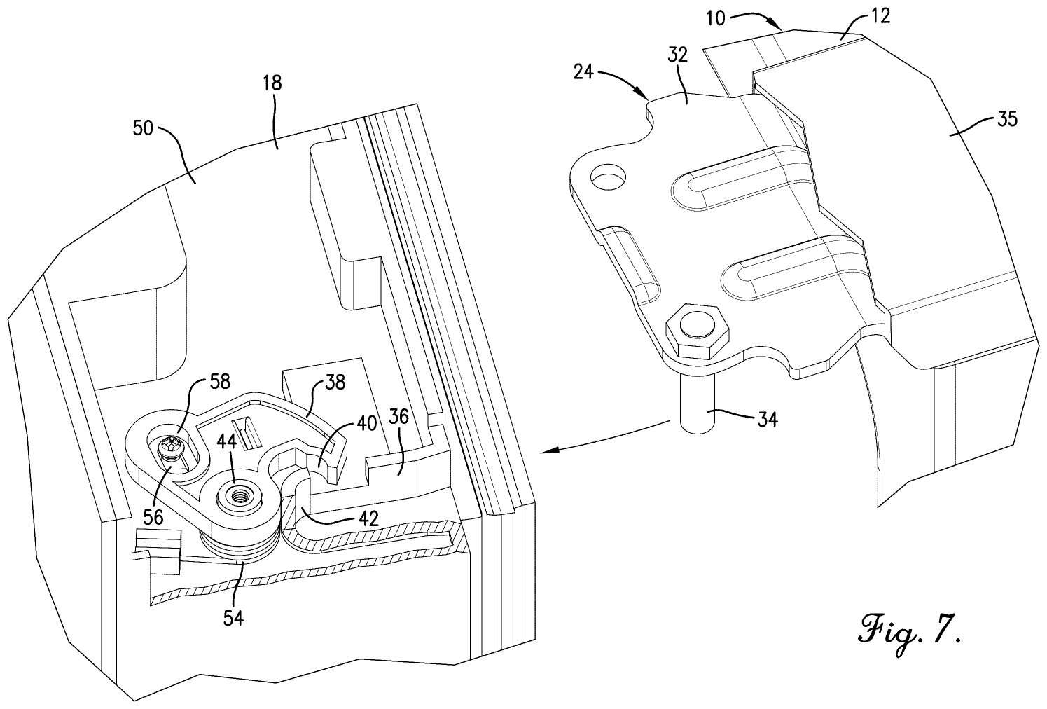

A door stop 68 may be provided with the upper right-side hinge 24 to limit the opening arc for the refrigerator door 18. In the illustrated embodiment, the door stop 68 may be an upward extension secured to the bolt 44 that engages against the mounting bracket 32 to stop further opening of the refrigerator door 18 once the desired maximum arc is reached. In FIG. 7, the door stop 68 has been removed to show a threaded hole 70 in the bolt 44 that can serve as one method of securing the door stop 68 to the bolt 44 by threading into the hole 70.

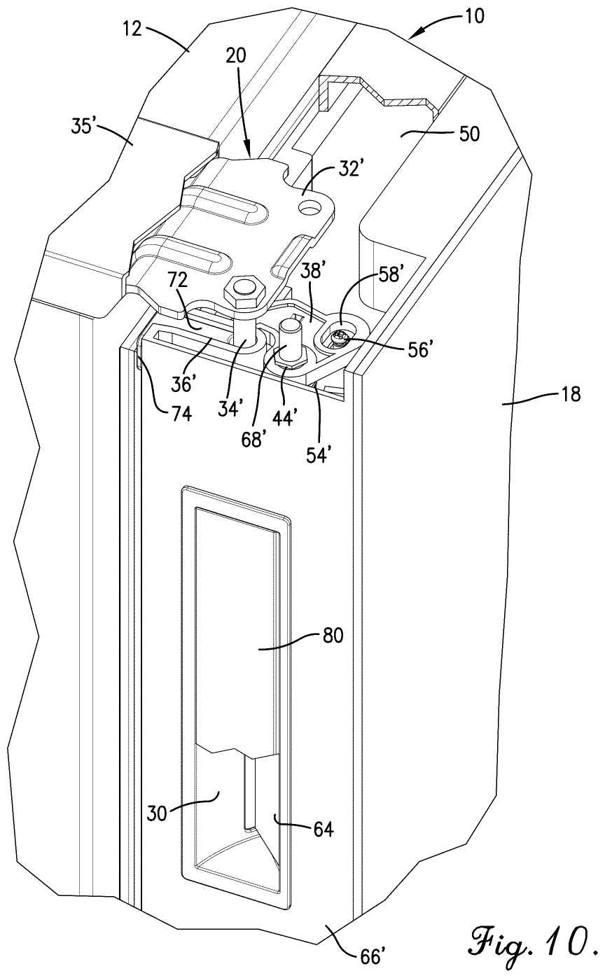

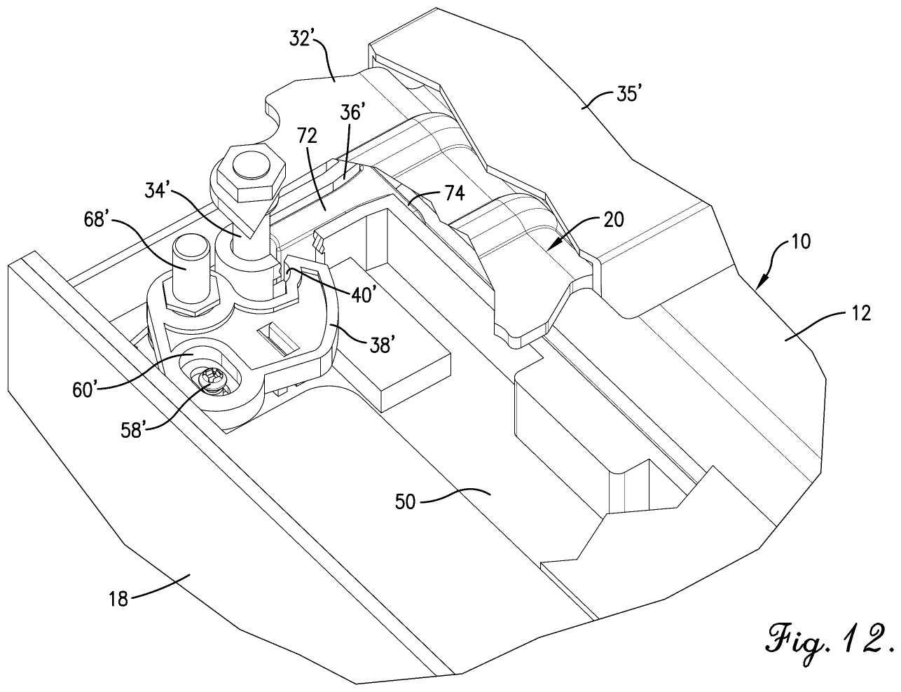

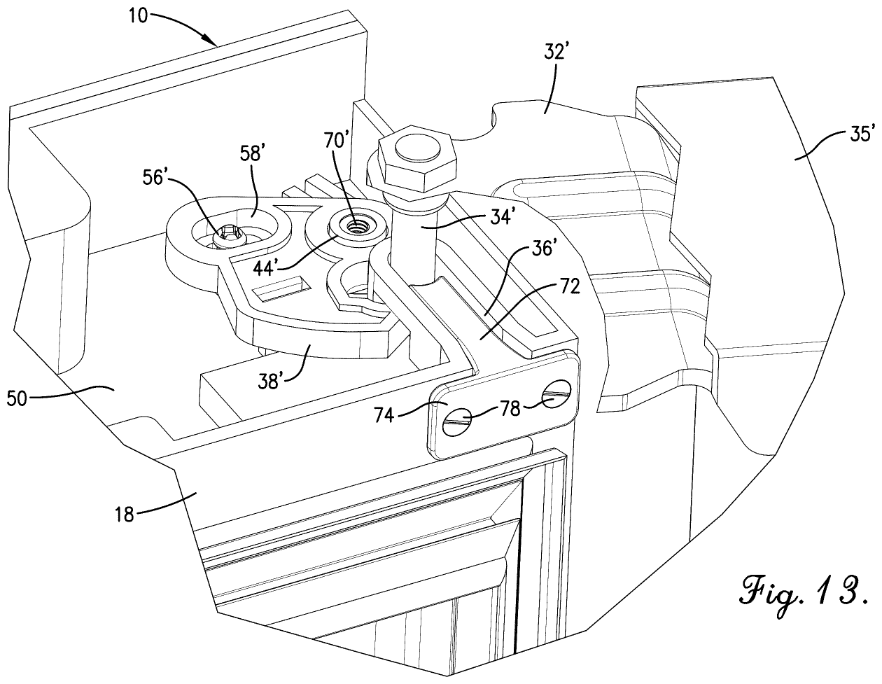

In the embodiment of FIGS. 10-13, the upper left-side hinge 20 has the mirror image of the components associated with the upper right-side hinge and the same reference numbers followed by the prime symbol are used for those like components.

In the present disclosure, the refrigerator 10 may be easily converted between right-hand swing opening and the left-hand swing opening of the refrigerator door 18 by removably securing a hinge block 72 so that it extends into the left guide channel 36′ as shown in FIGS. 10- 13 to abut and place the hinge pin 34′ in a captured condition for a right-hand swing opening or so that it extends into the right guide channel 36 to abut and place the hinge pin 34 in a captured condition for a left-hand swing opening of the refrigerator door 18. In the illustrated embodiment, the hinge block 72 displaces a portion of the left hinge catch 38′ that otherwise would extend into the left guide channel 36′ so that manipulation of the left handle 30 no longer releases the hinge pin 34′ from the captured condition achieved by the semicircular surface 40′ of the hinge catch 38′ abutting against the hinge pin 34′.

The hinge block 72 may be secured within the left guide channel 36′ in various ways, such as by providing a flanged surface 74 at an end opposite from an end that abuts the hinge pin 34′ and securing the flanged surface 74 to a rear face 76 of the upper frame 50 of the refrigerator door 18. The flanged surface 74 may be secured to the rear face 76 by a suitable adhesive or by fasteners 78 that extend through the flanged surface 74 and are secured to the upper frame 50. Another hinge block 72 may be inserted and secured within left guide channel 36′ (not shown) associated with the lower left hinge 22. Alternatively, the hinge block 72 may only be associated with either the left guide channel 36′ of the upper left hinge 20 or the lower left hinge 22.

If the refrigerator 10 is to be setup for the left-hand swing opening, the hinge block 72 is positioned in the right guide channel 36 of the upper right hinge 24 and/or the lower right hinge 24 in the same manner described above. When converting between the right-hand swing opening and the left-hand swing opening, the installed hinge block(s) 72 may be readily removed from the left guide channel 36′ and installed in the right guide channel 36, or vice versa.

In order to prevent a user from attempting to open the refrigerator door 18 using the inactivated right-side handle 28 or left-side handle 30, a handle block 80 may be inserted into the associated handle opening 64 to block user access to the inactivated right-side handle 28 or left-side handle 30. The handle block 80 may be removable so that it may be switch to the opposite handle opening 64 when the swing opening of the refrigerator door 18 is reversed.

It can thus be seen that the present disclosure allows conversion between right-hand and left-hand swing of the refrigerator door 18 to be easily and quickly accomplished without changing the hinge and handle location and without using the internal slide mechanism required for a dual-swing refrigeration door.

From the foregoing, it will be seen that this disclosure is one well adapted to attain all the ends and objects set forth above, together with other advantages which are obvious and inherent to the system and method. It will be understood that certain features and sub-combinations are of utility and may be employed without reference to other features and sub-combinations.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

In the specification and claims, reference will be made to several terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and the claim, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Range limitations may be combined and/or interchanged. Such ranges are identified and include all the sub-ranges contained therein unless context or language indicates otherwise.

As used herein, directional references, such as, “top,” “bottom,” “front,” “back,” “side,” and similar terms are used herein solely for convenience and should be understood only in relation to each other. For example, a component might in practice be oriented such that faces referred to herein as “top” and “bottom” are in practice sideways, angled, inverted, etc. relative to the chosen frame of reference.

The terms “coupled,” “fixed,” “attached to,” and the like refer to both direct coupling, fixing, or attaching, as well as indirect coupling, fixing, or attaching through one or more intermediate components or features, unless otherwise specified herein.

Although the present application sets forth a detailed description of embodiments of the retractable stairs 10, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

What is claim is:

1. A refrigerator comprising:
a cabinet defining a refrigeration compartment with a front opening;
a refrigerator door mountable for swinging movement between opened and closed positions at the front opening of the cabinet by a left-side hinge comprising a mounting bracket and a hinge pin and a right-side hinge comprising a mounting bracket and a hinge pin;
a left-side handle associated with the left-side hinge and manipulable to release a left hinge catch to free the hinge pin of the left-side hinge from a captured condition to allow a left-hand swing opening and closing of the refrigerator door about the hinge pin of the right-side hinge while in a captured condition;
a right-side handle associated with the right-side hinge and manipulable to release a right hinge catch to free the hinge pin of the right-side hinge from a captured condition to allow a right-hand swing opening and closing of the refrigerator door about the hinge pin of the left-side hinge while in a captured condition; and
a removable hinge block either positioned to place the hinge pin of the right-side hinge in the captured condition to allow the left-hand swing opening and closing of the refrigerator door or positioned to place the hinge pin of the left-side hinge in the captured condition to allow the right-hand swing opening and closing of the refrigerator door.

2. The refrigerator of claim 1, including a handle block either positioned to prevent manipulation of the right-side handle when the hinge block is positioned to place the hinge pin of the right-side hinge in the captured condition to allow the left-hand swing opening and closing of the refrigerator door or positioned to prevent manipulation of the left-side handle when the hinge block is positioned to place the hinge pin of the left-side hinge in the captured condition to allow the right-hand swing opening and closing of the refrigerator door.

3. The refrigerator of claim 2, including a left guide channel positioned in the refrigerator door and receiving the hinge pin of the left-side hinge and a right guide channel positioned in the refrigerator door and receiving the hinge pin of the right-side hinge.

4. The refrigerator of claim 3, wherein the hinge block is inserted into the right guide channel abutting the hinge pin of the right-side hinge when the hinge block is positioned to place the hinge pin of the right-side hinge in the captured condition to allow the left-hand swing opening and closing of the refrigerator door or the hinge block is inserted into the left guide channel abutting the hinge pin of the left-side hinge when the hinge block is positioned to place the hinge pin of the left-side hinge in the captured condition to allow the right-hand swing opening and closing of the refrigerator door.

5. The refrigerator door of claim 4, wherein the hinge block is removably secured to a frame of the refrigerator door.

6. The refrigerator door of claim 5, wherein the hinge block displaces the left hinge catch from within the left guide channel when the hinge block is inserted into the left guide channel and displaces the right hinge catch from within the right guide channel when the hinge block is inserted into the right guide channel.

7. The refrigerator door of claim 6, wherein the hinge block has one end that abuts the hinge pin in the left guide channel when the hinge block is inserted into the left guide channel and abuts the hinge pin the right guide channel when the hinge block is inserted into the right guide channel.

8. The refrigerator door of claim 7, wherein the hinge block has an opposite end that is flanged and secured to the frame of the refrigerator door.

9. A refrigerator comprising:
a cabinet defining refrigerator compartment with a front opening;
a refrigerator door mountable for swinging movement between opened and closed positions at the front opening of the cabinet by upper and lower left-side hinges each comprising a mounting bracket and a hinge pin and upper and lower right-side hinges each comprising a mounting bracket and a hinge pin;
a left-side handle associated with both the upper and lower left-side hinges and manipulable to release a left hinge catch to free the hinge pins of the upper and lower left-side hinges from a captured condition to allow a left-hand swing opening and closing of the refrigerator door about the hinge pins of the upper and lower right-side hinges while in a captured condition;
a right-side handle associated with the both the upper and lower right-side hinges and manipulable to release a right hinge catch to free the hinge pins of the upper and lower right-side hinges from a captured condition to allow a right-hand swing opening and closing of the refrigerator door about the hinge pins of the upper and lower left-side hinge while in a captured condition; and
removable hinge blocks either positioned to place the hinge pins of the upper and lower right-side hinges in the captured condition to allow the left-hand swing opening and closing of the refrigerator door or positioned to place the hinge pins of the upper and lower left-side hinges in the captured condition to allow the right-hand swing opening and closing of the refrigerator door.

10. The refrigerator of claim 9, including a handle block either positioned to prevent manipulation of the right-side handle when the hinge blocks are positioned to place the hinge pins of the upper and lower right-side hinges in the captured condition to allow the left-hand swing opening and closing of the refrigerator door or positioned to prevent manipulation of the left-side handle when the hinge blocks are positioned to place the hinge pins of the upper and lower left-side hinges in the captured condition to allow the right-hand swing opening and closing of the refrigerator door.

11. The refrigerator of claim 10, including left guide channels positioned in the refrigerator door and receiving the hinge pins of the upper and lower left-side hinges and right guide channels positioned in the refrigerator door and receiving the hinge pins of the upper and lower right-side hinges.

12. The refrigerator of claim 11, wherein the hinge blocks are inserted into the right guide channels abutting the hinge pins of the upper and lower right-side hinges when the hinge blocks are positioned to place the hinge pins of the upper and lower right-side hinges in the captured condition to allow the left-hand swing opening and closing of the refrigerator door or the hinge blocks are inserted into the left guide channels abutting the hinge pins of the upper and lower left-side hinge when the hinge blocks are positioned to place the hinge pins of the upper and lower left-side hinges in the captured condition to allow the right-hand swing opening and closing of the refrigerator door.

13. The refrigerator door of claim 12, wherein each of the hinge blocks is removably secured to a frame of the refrigerator door.

14. The refrigerator door of claim 13, wherein hinge blocks each displaces one of the left hinge catches from within the left guide channels when the hinge blocks are inserted into the left guide channels and displaces one of the right hinge catches from within the right guide channels when the hinge blocks are inserted into the right guide channel.

15. The refrigerator door of claim 14, wherein the hinge blocks each have one end that abuts one of the hinge pins in the left guide channels when the hinge blocks are inserted into the left guide channels and abuts the hinge pins the right guide channels when the hinge blocks are inserted into the right guide channels.

16. The refrigerator door of claim 15, wherein each of the hinge blocks has an opposite end that is flanged and secured to a frame of the refrigerator door.

17. A refrigerator comprising:
a cabinet defining refrigerator compartment with a front opening;
a refrigerator door mountable for swinging movement between opened and closed positions at the front opening of the cabinet by upper and lower left-side hinges each comprising a mounting bracket and a hinge pin and upper and lower right-side hinges each comprising a mounting bracket and a hinge pin;
a left-side handle associated with both the upper and lower left-side hinges and manipulable to release left hinge catches to free the hinge pins of the upper and lower left-side hinges from a captured condition to allow a left-hand swing opening and closing of the refrigerator door about the hinge pins of the upper and lower right-side hinges while in a captured condition;
a right-side handle associated with the both the upper and lower right-side hinges and manipulable to release right hinge catches to free the hinge pins of the upper and lower right-side hinges from a captured condition to allow a right-hand swing opening and closing of the refrigerator door about the hinge pins of the upper and lower left-side hinge while in a captured condition;
left guide channels positioned in the refrigerator door and receiving the hinge pins of the upper and lower left-side hinges;
right guide channels positioned in the refrigerator door and receiving the hinge pins of the upper and lower right-side hinges;
removable hinge blocks either positioned to place the hinge pins of the upper and lower right-side hinges in the captured condition to allow the left-hand swing opening and closing of the refrigerator door or positioned to place the hinge pins of the upper and lower left-side hinges in the captured condition to allow the right-hand swing opening and closing of the refrigerator door; and
a handle block either positioned to prevent manipulation of the right-side handle when the hinge blocks are positioned to place the hinge pins of the upper and lower right-side hinges in the captured condition to allow the left-hand swing opening and closing of the refrigerator door or positioned to prevent manipulation of the left-side handle when the hinge blocks are positioned to place the hinge pins of the upper and lower left-side hinges in the captured condition to allow the right-hand swing opening and closing of the refrigerator door,
wherein the hinge blocks are inserted into the right guide channels abutting the hinge pins of the upper and lower right-side hinges when the hinge blocks are positioned to place the hinge pins of the upper and lower right-side hinges in the captured condition to allow the left-hand swing opening and closing of the refrigerator door or the hinge blocks are inserted into the left guide channels abutting the hinge pins of the upper and lower left-side hinge when the hinge blocks are positioned to place the hinge pins of the upper and lower left-side hinges in the captured condition to allow the right-hand swing opening and closing of the refrigerator door,
wherein the hinge blocks each have one end that abuts one of the hinge pins in the left guide channels when the hinge blocks are inserted into the left guide channels and abuts the hinge pins the right guide channels when the hinge blocks are inserted into the right guide channels.

18. The refrigerator door of claim 17, wherein each hinge block is removably secured to a frame of the refrigerator door.

19. The refrigerator door of claim 18, wherein hinge blocks each displaces one of the left hinge catches from within the left guide channels when the hinge blocks are inserted into the left guide channels and displaces one of the right hinge catches from within the right guide channels when the hinge blocks are inserted into the right guide channel.

20. The refrigerator door of claim 19, wherein each hinge block has an opposite end that is flanged and secured to a frame of the refrigerator door.
